(19) United States
(12) Patent Application Publication
(10) Pub. No.: US 2003/0085113 A1
(43) Pub. Date: May 8, 2003

(54) Process and apparatus for cleaning and/or coating metal surfaces using electro-plasma technology

(76) Inventors: Edgar. H. Andrews, Welwyn (GB); Valerij Leontievich Steblianko, Magnitogorsk (RU); Edward O. Daigle JR., Convingon, LA (US)

Correspondence Address: John De Luca, Dykema Gossett PLLC, 1300 I Street N.W., Suite 300 W, Washington, DC, 20005-3306, US

(21) Appl. No.: 09/853,040

(22) Filed: May 11, 2001

(51) Int. Cl. H05F 3/00; C25C 7/00; C25B 9/00; C25D 17/00

(52) U.S. Cl. 204/164; 204/280; 204/242

(57) ABSTRACT

A process for cleaning an electrically conductive surface by arranging for the surface to form the cathode of an electrolytic cell in which the anode is maintained at a DC voltage in excess of 30 v and an electrical arc discharge (electro-plasma) is established at the surface of the workpiece by suitable adjustment of the operating parameters and the conductive medium in contact with the workpiece is an electrically conducting foam, characterised in that one or more vents are provided to allow the escape of gas from the foam-filled treatment zone.

The process can be adapted for simultaneously coating the metal surface by including ions of the species required to form the coating in the electrically conductive medium. Apparatus for carrying out the process is also disclosed, in particular an anode assembly which comprises an anode and a treatment chamber which is provided with one or more vents to allow the escape of gas from the treatment zone.

The present invention relates to an improved process and apparatus for cleaning and/or coating metal surfaces using electro-plasma technology.

Metals, notably, steel in its many forms, usually need to be cleaned and/or protected from corrosion before being put to their final use. As produced, steel normally has a film of mill-scale (black oxide) on its surface which is not uniformly adherent and renders the underlying material liable to galvanic corrosion. The mill-scale must therefore be removed before the steel can be painted, coated or metallised (e.g. with zinc). The metal may also have other forms of contamination (known in the industry as “soil”) on its surfaces including rust, oil or grease, pigmented drawing compounds, chips and cutting fluid, and polishing and buffing compounds. All of these must normally be removed. Even stainless steel may have an excess of mixed oxide on its surface which needs removal before subsequent use.

Traditional method of cleaning metal surfaces include acid pickling (which is increasingly unacceptable because of the cost and environmental problems caused by the disposal of the spent acid); abrasive blasting; wet or dry tumbling; brushing; salt-bath descaling; alkaline descaling and acid cleaning. A multi-stage cleaning operation might, for example, involve (i) burning-off or solvent-removal of organic materials, (ii) sand- or shot-blasting to remove mill-scale and rust, and (iii) electrolytic cleaning as a final surface preparation. If the cleaned surface is to be given ant-corrosion protection by metallising, painting or plastic coating, this must normally be done quickly to prevent renewed surface oxidation. Multi-stage treatment is effective but costly, both in terms of energy consumption and process time. Many of the conventional treatments are also environmentally undesirable.

Electrolytic methods of cleaning metal surfaces are frequently incorporated into processing lines such as those for galvanising and plating steel strip and sheet. Common coatings include zinc, zinc alloy, tin, copper, nickel and chromium. Stand-alone electrolytic cleaning lines are also used to feed multiple downstream operations. Electrolytic cleaning (or “electro-cleaning”) normally involves the use of an alkaline cleaning solution which forms the electrolyte while the workpiece may be either the anode or the cathode of the electrolytic cell, or else the polarity may be alternated. Such processes generally operate at low voltage (typically 3 to 12 Volts) and current densities from 1 to 15 Amps/dm². Energy consumptions thus range, from about 0.01 to 0.5 kWh/m². Soil removal is effected by the generation of gas bubbles which lift the contaminant from the surface. When the surface of the workpiece is the cathode, the surface may not only be cleaned but also “activated”, thereby giving any subsequent coating an improved adhesion. Electrolytic cleaning is not normally practicable for removing heavy scale, and this is done in a separate operation such as acid pickling and/or abrasive-blasting.

Conventional electrolytic cleaning and plating processes operate in a low-voltage regime in which the electrical current increases monotonically with the applied voltage. Under some conditions, as the voltage is raised, a point is reached at which instability occurs and the current begins to decrease with increasing voltage. The unstable regime marks the onset of electrical discharges at the surface of one or other of the electrodes. These discharges (“micro-arcs” or “micro-plasmas”) occur across any suitable non-conducting layer present on the surface, such as a layer of gas or vapour. This is because the potential gradient in such regions is very high.

### PRIOR ART

GB-A-1399710 teaches that a metal surface can be cleaned electrolytically without over-heating and without excessive energy consumption if the process is operated in a regime just beyond the unstable region, the “unstable region” being defined as one in which the current decreases with increasing voltage. By moving to slightly higher voltages, where the current again increases with increasing voltage and a continuous film of gas/vapour is established over the treated surface, effective cleaning is obtained. However, the energy consumption of this process is high (10 to 30 kWh/m²) as compared to the energy consumption for acid pickling (0.4 to 1.8 kWh/m²).

SU-A-1599446 describes a high-voltage electrolytic spark-erosion cleaning process for welding rods which uses extremely high current densities, of the order of 1000 A/dm², in a phosphoric acid solution.

SU-A-1244216 describes a micro-arc cleaning treatment for machine parts which operates at 100 to 350 V using an anodic treatment. No particular method of electrolyte handling is taught.

Other electrolytic cleaning methods have been described in GB-A-1306337 where a spark-erosion stage is used in combination with a separate chemical or electro-chemical cleaning step to remove oxide scale; in U.S. Pat. No. 5,232,563 where contaminants are removed at low voltages from 1.5 to 2V from semi-conductor wafers by the production of gas bubbles on the wafer surface which lift off contaminants; in EP-A-0657564, in which it is taught that normal low-voltage electrolytic cleaning is ineffective in removing grease, but that electrolytically oxidisable metals such as aluminum may be successfully degreased under high voltage (micro-arc) conditions by acid anodisation.

The use of jets of electrolyte situated near the electrodes in electrolytic cleaning baths to create high speed turbulent flow in the cleaning zone is taught for example in JP-A-08003797 and DE-A-4031234.

The electrolytic cleaning of radioactively contaminated objects using a single jet of electrolyte without overall immersion of the object, is taught in EP-A-0037190. The cleaned object is anodic and the voltage used is between 30 to 50V. Short times of treatment of the order of 1 sec are recommended to avoid erosion of the surface and complete removal of oxide is held to be undesirable. Non-immersion is also taught in CA-A-1165271 where the electrolyte is pumped or poured through a box-shaped anode with an array of holes in its base. The purpose of this arrangement is to allow a metal strip to be electro-plated on one side only and specifically to avoid the use of a consumable anode.

DE-A-3715454 describes the cleaning of wires by means of a bipolar electrolytic treatment by passing the wire through a first chamber in which the wire is cathodic and a second chamber in which the wire is anodic. In the second chamber, a plasma layer is formed at the anodic surface of the wire by ionisation of a gas layer which contains oxygen. The wires immersed in the electrolyte throughout its treatment.

EP-A-0406417 describes a continuous process for drawing copper wire from copper rod in which the rod is plasma cleaned before the drawing operation. The “plasmatron” housing is the anode and the wire is also surrounded by an inner co-axial anode in the form of a perforated U-shaped sleeve. In order to initiate plasma production the voltage is maintained at a low but unspecified value, the electrolyte level above the immersed wire is lowered, and the flow-rate decreased in order to stimulate the onset of a discharge at the wire surface.

Whilst low voltage electrolytic cleaning is widely used to prepare metal surfaces for electro-plating or other coating treatments, it cannot handle thick oxide deposits such as mill-scale without an unacceptably high expenditure of energy. Such electrolytic cleaning processes must normally be used, therefore, in conjunction with other cleaning procedures in a multi-stage operation.

WO-A-97/35052 describes an electrolytic process for cleaning electrically conducting surfaces using an electro-plasma (arc discharge) in which a liquid electrolyte flows through one or more holes in an anode held at a high DC voltage and impinges on the workpiece (the cathode) thus providing an electrically conductive path. The system is operated in a regime in which the electrical current decreases or remains substantially constant with increase in the voltage applied between the anode and the cathode and in a regime in which discrete bubbles of gas and/or vapour are present on the surface of the workpiece during treatment.

WO-A-97/35051 describes an electrolytic process for cleaning and coating electrically conducting surfaces which is similar to the process as described in WO-A-97/35052 except that the anode comprises a metal for metal-coating of the surface of the workpiece.

In operating the processes of WO-A-97/35051 and WO-A-97/35052 an arc discharge or electro-plasma is formed on the surface of the workpiece and is established within the bubble layer. The plasma has the effect of rapidly removing mill-scale and other contaminants from the surface of the work-piece, leaving a clean metal surface which may also be passivated (resistant to further oxidation).

If, additionally, the anode is constructed from a non-inert material, such as a non-refractory metal, then metal atoms are transferred from the anode to the cathode, providing a metal coating on the cleaned surface.

Coating may also be achieved under the regime of operation described above by using an inert anode and an electrolyte containing ions of the metal to be coated as described in WO-A-99/15714. In this case the process becomes a special form of electroplating, but because it occurs at high voltage in the presence of an arc discharge the plating is faster than normal electroplating and the coating has better adhesion to the substrate metal.

WO-A-98/32892 describes a process which operates essentially in the manner described above but uses a conductive gas/vapour mixture as the conductive medium. This gas/vapour mixture is generated within a two- or multi-chambered anode before being ejected into the working gap through holes in the anode. The gas/vapour mixture is generated by heating an aqueous electrolyte within the anode chambers to boiling point or above, and the anode chambers may be heated either by the main electric current or by independent electrical heaters.

WO-A-01/09410 describes a process and apparatus suitable for cleaning and/or coating an electrically conducting surface such as a metal workpiece using an electro-plasma process essentially similar to that disclosed in WO-A-97/35052 and WO-A-99/15714, except that the electrically conductive medium filling the space (or ‘working zone’) between the anode and the cathode (workpiece) consists of an electrolyte foam comprising a gas/vapour phase and a liquid phase. The use of a conducting foam to fill the treatment zone provides several benefits including a reduced current flow leading to reduced power consumption, more uniform treatment of the workpiece surface, and the facility to employ a larger working distance (gap) between the anode and the cathode.

The foam is produced by any suitable means including heating a liquid electrolyte to its boiling point either prior to injection into the working gap or within the working gap itself.

A residual problem with the invention of WO 01/09410 is that the plasma which is produced on the surface of the workpiece, and which is instrumental in effecting the desired cleaning and/or coating, frequently suffers from instability. That is, the plasma does not ‘burn’ uniformly and consistently over the whole workpiece surface within the treatment zone for an indefinite period of time. In extreme cases the plasma is quenched and the process is arrested.

Since in most industrial applications the workpiece is moved continuously through the treatment zone at a uniform speed, an unstable plasma gives rise to unacceptably non-uniform cleaning or coating along the length of the workpiece. Ideally, the process should remain uniform and consistent for a period long enough to run a cleaning or coating line for up to seven days without interruption.

We have now developed ways to improve the stability of the plasma in the case where the electrically conductive medium in contact with the workpiece in the treatment zone is an electrolyte foam. The improvement is obtained by preventing the fluctuations of gas-pressure within the foam-filled treatment zone that occur due to the production of hydrogen at the workpiece surface. This is accomplished by (1) introducing means to vent gas (mainly hydrogen) from the treatment zone and (2) optionally, confining the foam to a smaller volume adjacent to the workpiece by introducing a non-conducting perforated screen which separates liquid electrolyte in contact with the anode from foam in contact with the cathode (workpiece). The non-conducting screen has the further benefit of preventing the workpiece accidentally coming into contact with or close proximity to the anode causing an electrical short-circuit or ‘flashover’ which can damage both the apparatus and the workpiece.

### SUMMARY OF THE INVENTION

Accordingly in a first aspect the invention the invention provides a process for cleaning an electrically conductive surface (workpiece) by arranging for the surface to form the surface of a cathode of an electrolytic cell in which the anode is maintained at a DC voltage in excess of 30 v and an electrical arc discharge (electro-plasma) is established at the surface of the workpiece by suitable adjustment of the operating parameters and the conductive medium in contact with the workpiece is an electrically conducting foam characterised in that one or more vents are provided to allow the escape of gas from the foam-filled treatment zone and, optionally, in that-the foam is confined to a region of reduced volume around the workpiece by means of a non-conductive perforated screen.

The venting of the treatment zone prevents pressure fluctuation within this zone and the confinement of the foam further reduces the magnitude of any pressure fluctuations.

In a second aspect the present invention provides a process for coating an electrically conductive surface (workpiece) by arranging for the surface to form the surface of a cathode of an electrolytic cell in which the anode is maintained at a DC voltage in excess of 30 v and an electrical arc discharge (electro-plasma) is established at the surface of the workpiece by suitable adjustment of the operating parameters and the conductive medium in contact with the workpiece is an electrically conducting foam containing ions of the metal or metals to form the coating characterized in that one or more vents are provided to allow the escape of gas from the foam-filled treatment zone and, optionally, in that the foam is confined to a region of reduced volume around the workpiece by means of a non-conductive perforated screen.

The venting of the treatment zone prevents pressure fluctuations within this zone and the confinement of the foam further reduces the magnitude of any pressure fluctuations.

In another aspect the present invention provides an anode assembly which comprises a treatment zone consisting of an anode and a treatment chamber provided with one or more vents to allow the escape of gas from the treatment zone and means to confine an electrolytic foam so that it fills the treatment zone uniformly together with inlets and outlets for the said foam.

In a further aspect the present invention provides an anode assembly which comprises an anode and a treatment chamber separated into a first region to contain liquid electrolyte in contact with the anode and a second region to contain a conductive foam in contact with a workpiece, the two regions being separated by a perforated non-conductive screen which allows liquid electrolyte to enter the foam-region to be converted into foam, both the first and second regions being provided with one or more vents to allow the escape of gas from the treatment zone, and the assembly being provided with one or more inlets and/or outlets for liquid electrolyte and foam.

In a still further aspect the present invention provides apparatus for cleaning or coating an electrically conducting surface which comprises one or more anode assemblies as defined above suitably disposed with respect to the surface or surfaces to be treated; means to vent gas from all regions of the assemblies; means to continuously move a workpiece to be treated through the treatment zone between the anode assemblies; means to open and close the treatment zone; and means to control the supply of foam to and the removal of foam from the treatment zone.

In a yet further aspect the present invention the apparatus for cleaning or coating an electrically conducting surface as described above comprises a series of treatment zones through which a workpiece to be treated passes sequentially, with means to cool the workpiece between the said treatment zones by water quenching or otherwise to prevent overheating of the workpiece.

### DESCRIPTION OF THE INVENTION

The use and advantages of foam as the conductive medium in electro-plasma cleaning and coating are discussed in WO-A-01/09410. The foam, by virtue of its gas/vapour content, has a lower conductivity than the corresponding liquid electrolyte. This reduces the current flow during cleaning/coating and thus reduces power consumption and improves the economics of the process. Other advantages are that more uniform treatment of workpiece surfaces can be obtained and the process tolerates larger working distances between anode and workpiece.

However, we have found that the plasma on the surface of the workpiece tends to be unstable when foam is used. The reason for this is, we believe, the pressure fluctuations that occur within the foam due mainly to the production of hydrogen gas by electrolysis at the surface of the workpiece. Local build-up of gas pressure in the treatment zone tends to suppress the plasma, either due to back-pressure reducing the flow of electrolyte to the treatment zone or for some other reason. We have found that providing one or more vents to allow the escape of gas from the treatment zone produces a great improvement in the stability of the plasma and allows uninterrupted operation of the process over a period of days. This level of stability has not been attained without such venting means.

Furthermore, for reasons that are not obvious, venting gas from the treatment zone also causes a reduction in electrical current at constant voltage, reducing the power consumption of the process. This effect is clearly visible when the vents are temporarily closed and reopened.

Pressure fluctuations can be further reduced by restricting the volume of foam around the workpiece, presumably because large point-to-point fluctuations are less sustainable in a smaller volume. Such a volume restriction has been found to contribute to plasma stability and is conveniently brought about by introducing a non-conductive perforated screen between the anode and the workpiece. Liquid electrolyte is fed into the region on the anode side of the screen and does not foam but passes through the perforations in the screen into the region adjacent to the workpiece, where foaming occurs due to resistive heating at the workpiece surface. Clearly, the foam volume is restricted to the space between the screen and the workpiece and no longer occupies the whole space between the anode and the workpiece.

The foam region is vented to allow the escape of gas, and the liquid region adjacent to the anode is also vented since some gas finds its way back into the liquid region through the screen perforations. The use of the non-conductive screen has the further advantage that it prevents any adventitious contact or close approach of the workpiece with or to the anode. Workpieces are frequently run at high speed through cleaning stations, several hundred feet per minute being typical. Under such conditions the workpiece may vibrate or wander away from its nominal position in the cell, leading to the danger of sparking between anode and workpiece, damaging the latter.

Foam

Generally, the term “foam” refers to a medium containing at least 20% by volume, preferably 30% by volume of gas and/or vapour in the form of bubbles or cells, the remainder of the medium being liquid. More preferably at least 50% by volume of the foam is gas and/or vapour in the form of bubbles or cells.

Foam production is most easily obtained by boiling the electrolyte in contact with the workpiece surface. This is facilitated by pre-heating the liquid electrolyte, preferably to a temperature around 70° C. Electrical resistive heating at the workpiece surface then causes a further rise in temperature to produce boiling and foam formation. Under some circumstances this resistive heating can be sufficient to cause boiling of the electrolyte without pre-heating, but pre-heating is preferred. The foam used in the present invention is generally formed from an aqueous electrolyte such as a solution of metal salts in water. Foaming agents, surfactants, viscosity modifiers or stabilisers may be added to optimise the properties of the foam.

However, methods of foam production other than boiling may also be employed, such as the incorporation in an electrolyte of thermally-activated blowing agents; the release of pressure from a liquid electrolyte super-saturated with a volatile substance (as when a bottle of champagne is shaken and opened); the mechanical injection of a liquid electrolyte with steam or another vapour or gas; the mechanical ‘whipping’ of a relatively viscous electrolyte; or the combination of two liquid streams which react together chemically to produce a gas causing the mixture to ‘blow’ into a foam; or other means known in the art for creating liquid foams.

If the foamed electrolyte contains only ions of metals that react with water, such as sodium or potassium, the workpiece is cleaned. If other metal ions are present they will, additionally, be deposited to form a coating on the cleaned workpiece.

Operating Parameters

The process of the present invention is operated in a manner such that an electrical are discharge (electro-plasma) is established at the surface of the workpiece. The operating parameters that can be adjusted to provide the necessary conditions for the establishment of an electro-plasma include; the voltage; the chemical composition of the electrolyte; the temperature of the electrolyte; the rate at which the electrolyte is supplied; and the distance between the anode and the cathode). The simplest way to establish a plasma for any given cell geometry and electrolyte temperature is to set the voltage at a sufficiently high level (generally more than 30 v, preferably more than 80 v) and gradually increase the electrolyte flow rate until plasma occurs. Suitable operating parameters are disclosed in detail in WO-A-97/35051 and WO-A-97/35052.

Typical operating parameters are therefore

(a) a voltage in the range of from 30 v to 250 v;

(b) an anode-to-cathode separation, or the working distance, of from 3 to 30 mm, preferably 5 to 20 mm; and

(c) an electrolyte flow rate of from 0.02 to 0.2 litres per minute per square centimetre of anode (l/min.cm²).

Electrolyte and Foam Handling

Means are provided for introducing a liquid electrolyte into the treatment zone (where it is caused to foam) together with means for removing the foam from the treatment zone and filtering, rejuvenating and re-circulating spent foam. This invention further provides for the containment of the foam within the working gap by means of an enclosure through which the workpiece can move without significant leakage of foam. The pressure within the working gap of an enclosed system may be maintained at above atmospheric pressure.

Whether the foam is introduced into the treatment zone through holes in the anode, holes in a non-conducting screen, or otherwise, it is necessary to provide means for the used foam to be removed from the working region. To this end, an exhaust port is provided to drain away used foam. In most cases the used foam can be condensed to liquid, cleaned, filtered, rejuvenated (e.g. by adjustment of pH or salt concentration), re-heated, and re-circulated.

Since one important application of the invention is its use in continuous processes, where the workpiece moves continuously through the treatment zone, the enclosure must allow the workpiece to move while maintaining a reasonable seal. This can be achieved by using flexible rubber seals around the moving workpiece.

Workpieces

Any shape or form of workpiece such as sheet, plate, wire, rod, tube, pipe or complex shapes may be treated, using if necessary shaped anode surfaces to provide a reasonably uniform working distance. The process of the present invention may be used in various ways to clean or coat one side or both sides of a flat article simultaneously by the use of multiple anodes suitably positioned with respect to the workpiece. Both static and moving workpieces may be treated in accordance with the present invention.

When the process of the present invention is used to coat a workpiece the positive ions to form a coating on the workpiece may be derived from one or more sacrificial anodes, and/or from the original composition of the electrically conductive foam.

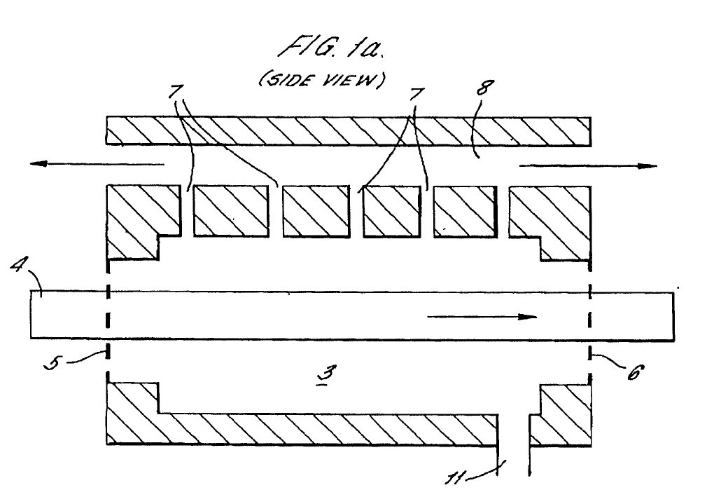

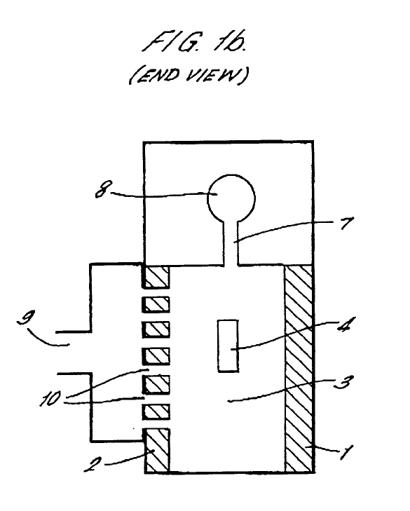

The present invention will be further described with reference to FIGS. 1 to 6 of the accompanying drawings, in which:

FIGS. 1a and 1b represent schematically a cell in which the treatment zone is vented to allow the escape of gas;

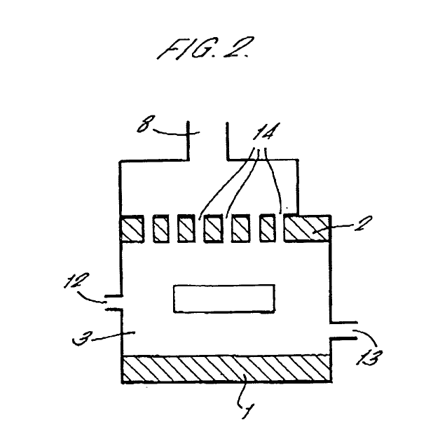

FIG. 2 shows a different arrangement of such a cell in which the vents pass through the anode;

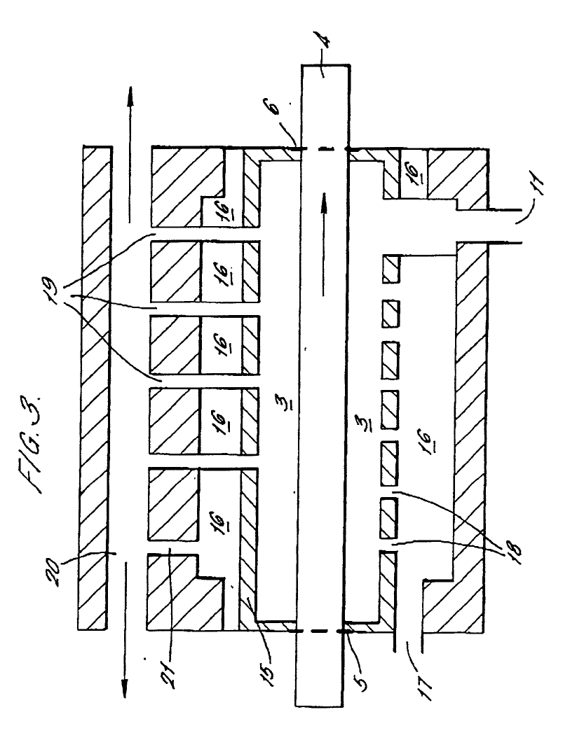

FIG. 3 shows a vented cell in which the foam region is restricted in volume by the use of a perforated screen;

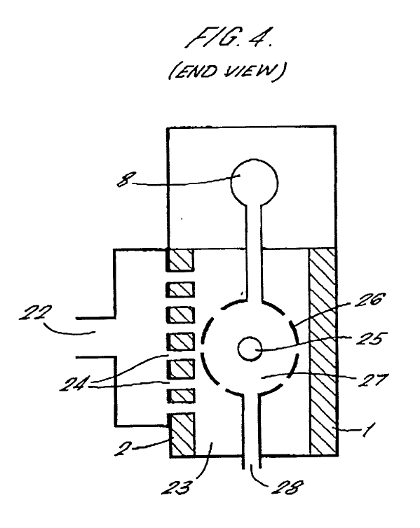

FIG. 4 is an end view of FIG. 3 and the workpiece is a wire or rod;

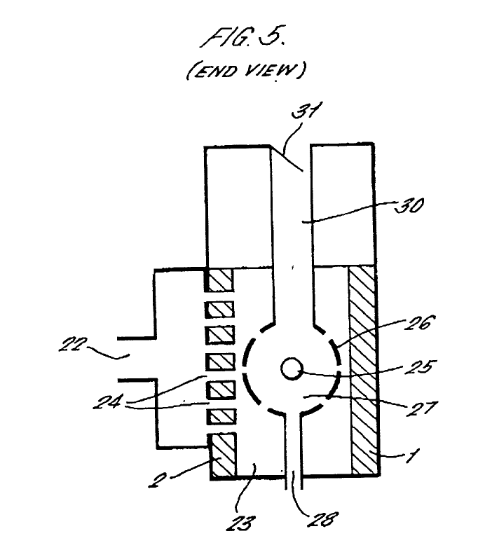

FIG. 5 is as FIG. 4 except that the gas vent is a continuous slit partially closed by a flexible rubber flap. The arrangement allows a continuous wire to be lowered into the treatment chamber without cutting or threading; and

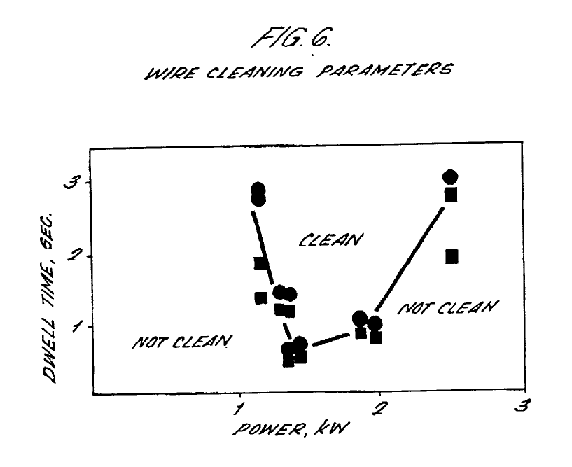

FIG. 6 is a graph illustrating the parameters for wire cleaning of Example 1.

### DETAILED DESCRIPTION OF DRAWINGS

Referring to FIGS. 1a and 1b of the drawings, an anode assembly comprises an anode consisting of a front 1 and a back plate 2 of a closed treatment chamber 3 (the anode plates are only visible in FIG. 1b). The treatment chamber 3 is closed in the sense that a moving workpiece 4 passes through flexible rubber seals 5 and 6 at the points of entry and exit so that the electrolyte foam contained within the chamber is substantially prevented from leaking from the treatment chamber 3 at these points. Multiple gas vents 7 at the top of the treatment chamber 3 allow the escape of hydrogen and any other gas that may otherwise accumulate in the treatment chamber 3 and cause plasma instability. The vents 7 open into a large gas exhaust channel 8 through which the gas is led away and disposed of in a safe manner. Some foam escapes with the gas but condenses into liquid and can be drawn off and added to the re-circulating electrolyte.

Liquid electrolyte is fed into the treatment chamber 3 through an entry port 9 and holes 10 in one of the anode plates 2 (FIG. 1b) and is converted to foam by resistive heating at the workpiece 4, the foam expanding to fill the treatment chamber 3. Foam can, however, drain from the chamber through a drainage port 11 shown in FIG. 1a, and is condensed to liquid and re-circulated.

The workpiece 4, which serves as the cathode of the electrolytic cell, is fed through the treatment chamber by roller guides (not shown) which also serve to earth the workpiece 4.

Referring to FIG. 2 of the drawings, an alternative arrangement of that of FIG. 1b is shown in which liquid electrolyte is fed into the treatment chamber 3 directly through an inlet 12 rather than through holes in the anode plate(s). It is converted into foam by resistive heating at the workpiece surface and the foam exits from the chamber through an outlet 13 as shown.

In this case, gas vents 14 consist of holes in the anode plate 2 which allow hydrogen and other gases to escape from the treatment chamber 3, thus enhancing the stability of the plasma. The gases are drawn off and disposed of safely.

Referring to FIG. 3 of the drawings, an electrolytic cell is shown which is similar to that shown in FIG. 1a except that the foam region is restricted in volume by means of a non-conducting perforated screen 15 consisting of an inner cylinder of PTFE which entirely surrounds the workpiece 4, except where the workpiece enters and leaves the cell through flexible seals 5 and 6 at the ends of the cylinder. Liquid electrolyte 16 is fed through an inlet 17 into a closed region surrounding the inner cylinder 15 where it is in contact with the anodes 1 and 2. The presence of the inner cylinder 15 prevents the electrolyte 16 from foaming in this region. From the liquid outer region the electrolyte 16 can pass into the treatment region within the inner cylinder 15 through the perforations 18 in the inner cylinder wall. Once it has done so it foams due to resistive heating at the workpiece surface 4 and the foam substantially fills the inner cylinder 15, being drained from this region by a foam outlet 11. Gas escapes from the inner cylinder through vents 19 as shown into an exhaust pipe 20, as shown.

Although the liquid region adjacent to the anodes is closed, and has no outlet for liquid, any gas finding its way into this region by back flow through the perforations 18 in the inner cylinder 15, can be exhausted through one or more vents 21 as shown.

Clearly, the inner cylinder 15 forming the perforated screen can be replaced by an inner chamber of rectangular cross section or of any cross sectional shape as may be required for differently shaped workpieces.

Referring to FIG. 4 of the drawings, this shows an end view of an anode assembly similar to that illustrated in FIG. 3 except that the liquid electrolyte is fed via an entry port 22 into the liquid region 23 adjacent to the anodes 1 and 2 through holes 24 in one of the anode plates. Additionally, FIG. 4 shows a workpiece 25 of circular cross-section such as wire or rod. A perforated inner cylinder 26 surrounds the workpiece 25. As before, the workpiece 25 is guided along the axis of the inner cylinder 26 by appropriately placed rollers (not shown) which also serve to earth the workpiece 25. The treatment chamber 27 formed between the workpiece 25 and the perforated cylinder 26 is filled with foam. The chamber 27 is connected to a foam drainage channel 28. The foam filled treatment chamber 27 is vented via gas vents 29 to an exhaust 30.

Referring to FIG. 5 of the drawings, an anode assembly is provided which is similar to that shown in FIG. 4 except that the gas vent 30 from the treatment chamber 27 is a continuous slit running the full length of the assembly. The slit is partially closed by a flexible rubber flap 31 to prevent undue expulsion of foam through the vent. This arrangement allows a continuous workpiece, such as a wire, to be lowered into or removed from the treatment chamber without cutting or threading.

### EXAMPLE 1

We now describe, by way of an example, the cleaning of a 1.3 mm diameter steel wire with a heavy, lead-contaminated layer of patenting scale.

The equipment consisted of a four-inch long anode assembly having a perforated inner cylinder of 10 mm internal diameter of the kind shown in FIG. 4. The wire was run from reel to reel and was guided along the axis of the inner cylinder by roller guides which also served to earth the wire. The electrolyte was a 13% by weight solution of sodium bicarbonate in water and was maintained at a temperature of 73° C.

The DC voltage on the anode was set at 100 v and the wire speed at 7.0 ft/min. The electrolyte flow rate was increased (within the range 1.5 to 4.0 litres/minute) until plasma was seen to form on the wire, which could be viewed through two viewing ports in the anode casing. Once the flow rate was high enough to produce a stable plasma, the wire emerging from the treatment zone was observed through a magnifier to be visually clean with a ‘satin’ finish. The degree of chemical cleanness of the wire was subject to sample checks later using the Energy Dispersive Spectroscopy (EDS) facility on a scanning electron microscope. The current being drawn by the anode was recorded.

The speed of the wire was then increased in increments until a speed was reached at which small regions of residual scale could be detected on the emerging wire. This speed and the previous speed (at which the wire was still completely clean) bracket the ‘critical speed’ at which the wire is just rendered completely clean. The two ‘bracketing’ speeds were recorded.

Keeping the voltage at 100 v, the electrolyte flow rate was increased to a new level and recorded. The current increased with increasing flow-rate and its new value was noted. The wire-speed experiment was repeated and a new pair of ‘bracketing’ speeds found. The whole experiment was repeated for a range of electrolyte flow-rates and then again for a series of anode voltages.

From the length L of the anode (in feet) and the critical speed S_{c} of the wire (in feet per second) a ‘critical dwell time’ T_{c} can be defined as L/S_{c} (in seconds). This is the time of plasma treatment required to just clean the wire completely.

When the critical dwell time is plotted against the power consumption (voltage×current in kW) a single smooth curve results for all flow rates and voltages. An example is shown in FIG. 6 where the bracketing speeds have been used to plot two points for each different power consumption (power consumption changes with flow rate and voltage). In FIG. 6 the circles represent ‘clean-wire’ points and the squares represent ‘not-clean-wire points’. The curve is drawn between the bracketing points and marks the line of separation between the upper region in which the wire is completely cleaned and the lower region where the dwell time is too short to obtain complete cleaning.

It can be seen that the dwell time required to clean the wire has a minimum in the region of 1.5 to 2.0 kW power consumption. The process is most efficient in this range of power supply. At lower power, there is insufficient energy available to clean the wire, while at higher power the wire surface probably re-oxidizes, making good cleaning difficult to achieve. It is clearly important to operate in the high efficiency zone.

### EXAMPLE 2

Metal coating can be carried out by using a salt of an insoluble metal in the electrolyte. The deposition of a dense coating of nickel having an average thickness of 18 microns on a 2.59 mm diameter steel wire, the wire having been previously cleaned by the process described in example 1 is achieved under the following conditions.

The anode used was of the kind shown in FIG. 1 and the electrolyte was an aqueous solution of nickel sulphate containing 5% by weight of nickel. The electrolyte was pre-heated to 70° C. The following parameters were employed;

| | | |
|---|---|---|
| DC Voltage | 180 | v |
| Electrolyte flow-rate | 2.0 | litres/min |
| Wire speed | 4.6 | ft/min |
| Dwell time | 8.8 | sec |
| Run time | 5 | min |

The coating achieved is dense and well-adhered. Its thickness varies between 14 and 22 microns.

The adhesion and wear-rate of the coating were measured. Adhesion was 37 kg/cm² and the wear-rate was very low at 3.2×10⁻⁶ mm³/mN.

The coating composition determined using EDS was as follows;

| | |
|---|---|
| Nickel | 90.5% |
| Aluminium | 1.3% |
| Zinc | 1.2% |
| Iron | 4.4% |
| Silicon | 1.8% |
| Other | 0.8% |

In EDS it is normal to find some environmental contamination; elements recorded at less than 2% are not necessarily present in the sample itself. The figure for iron, however, is significant and indicates that there is some alloying present between substrate and coating.

1. A process for cleaning an electrically conductive surface by arranging for the surface to form the surface of a cathode of an electrolytic cell in which the anode is maintained at a DC voltage in excess of 30 v and an electrical arc discharge (electro-plasma) is established at the surface of the workpiece by suitable adjustment of the operating parameters and the conductive medium in contact with the workpiece is an electrically conducting foam, characterised in that one or more vents are provided to allow the escape of gas from the foam-filled treatment zone.

2. A process for coating an electrically conductive surface by arranging for the surface to form the surface of a cathode of an electrolytic cell in which the anode is maintained at a DC voltage in excess of 30 v and an electrical arc discharge (electro-plasma) is established at the surface of the workpiece by suitable adjustment of the operating parameters and the conductive medium in contact with the workpiece is an electrically conducting foam containing ions of the metal or metals to form the coating, characterised in that one or more vents are provided to allow the escape of gas from the foam-filled treatment zone.

3. A process as claimed in claim 1 or claim 2 wherein the foam is confined to a region of reduced volume around the workpiece by means of a non-conductive perforated screen.

4. A process as claimed in claim 2 in which the positive ions to form a coating on the workpiece are derived from one or more sacrificial anodes.

5. A process as claimed in claim 2 in which the positive ions used to form a coating on the workpiece are derived both from one or more sacrificial anodes and from the original composition of the electrically conductive medium.

6. A process as claimed in claim 1 or claim 2 in which the foam comprises at least 30% by volume of gas/vapour.

7. A process as claimed in claim 1 or claim 2 in which the foam is introduced into the working gap through one or more holes in the working surface of the anode.

8. A process as claimed in claim 1 or claim 2 in which the foam is introduced into the working gap other than through the anode.

9. A process as claimed in claim 1 or claim 2 in which the electrically conductive foam is generated by boiling an aqueous electrically conductive electrolyte.

10. A process as claimed in claim 1 or claim 2 wherein the foam is generated by mechanical means.

11. A process as claimed in claim 1 or claim 2 in which the foam formation, properties and stability are controlled by adding to the electrically conductive medium one or more of a foaming agent, surfactant, viscosity modifier or stabiliser.

12. A process as claimed in claim 1 or claim 2 in which the foam is formed by electrical resistive heating at the workpiece surface.

13. A process as claimed in claim 1 or claim 2 in which the working gap is enclosed to contain the foam.

14. A process as claimed in claim 13 in which the pressure within the working gap is maintained above atmospheric pressure.

15. A process as claimed in claim 1 or claim 2 wherein the used foam is condensed, cleaned, filtered, rejuvenated, re-formed an recirculated to the treatment zone.

16. An anode assembly which comprises a treatment zone consisting of an anode and a treatment chamber provided with one or more vents to allow the escape of gas from the treatment zone and means to confine an electrolytic foam so that it fills the treatment zone uniformly together with inlets and outlets for the said foam.

17. An anode assembly which comprises an anode and a treatment chamber separated into a first region to contain liquid electrolyte in contact with the anode and a second region to contain a conductive foam in contact with a workpiece, the two regions being separated by a perforated non-conductive screen which allows liquid electrolyte to enter the foam-region to be converted into foam both the first and second regions being provided with one or more vents to allow the escape of gas from the treatment zone, and the assembly being provided with one or more inlets and/or outlets for liquid electrolyte and foam.

18. Apparatus for cleaning or coating an electrically conducting surface which comprises one or more anode assemblies as claimed in claim 16 or claim 17 suitably disposed with respect to the surface or surfaces to be treated; means to vent gas from all regions of the assemblies; means to continuously move a workpiece to be treated through the treatment zone between the anode assemblies; means to open and close the treatment zone; and means to control the supply of foam to and the removal of foam from the treatment zone.

19. Apparatus for cleaning or coating an electrically conducting surface as claimed in claim 18 which comprises a series of treatment zones through which a workpiece to be treated passes sequentially, with means to cool the workpiece between the said treatment zones by water quenching or otherwise to prevent over-heating of the workpiece.

20. Apparatus as claimed in claim 18 wherein the treatment zone is sealed by means of flexible seals.

21. Apparatus as claimed in claim 17 or claim 18 wherein the treatment zone is provided with at least one inlet for the injection of the foam into the treatment zone and at least one outlet for the removal of the foam from the treatment zone.
